(19) United States
(12) Patent Application Publication
(10) Pub. No.: US 2019/0183278 A1
(43) Pub. Date: Jun. 20, 2019

(54) SANITARY HOSPITAL CURTAIN

(71) Applicant: Curtain Care Plus, Inc., Clifton, NJ (US)

(72) Inventors: Mason Kirsch, Caldwell, NJ (US); James Kazanjian, Chaddsford, PA (US)

(73) Assignee: Curtain Care Plus, Inc.

(21) Appl. No.: 16/189,013

(22) Filed: Nov. 13, 2018

Related U.S. Application Data
(60) Provisional application No. 62/598,793, filed on Dec. 14, 2017.

(51) Int. Cl. A47H 23/08; A61G 12/00; D01F 6/06

(52) U.S. Cl. CPC A47H 23/08; A47H 13/04; D01F 6/06; A61G 12/00

(57) ABSTRACT

A privacy curtain for use in hospitals and other medical facilities having a removable cleanable surfaces on its front and back handhold points, which removable surfaces are constructed from medical grade impervious antimicrobial materials, such as vinyl being removably attached via snaps or Velcro or some other fastening system.

### CROSS REFERENCE TO RELATED APPLICATION

This application claims the benefit of U.S. Provisional Application No. 62/598,793 filed Dec. 14, 2017

### FIELD OF THE INVENTION

The instant invention relates to privacy curtains used in hospital and other medical treatment facility settings.

### BACKGROUND OF THE INVENTION

A hospital curtain (also known as a cubicle or privacy curtain) is a dividing cloth used in a medical treatment facility that provides a private enclosure for one or more patients. The curtain is usually made from inherently flame retardant fabric, and is suspended from a supporting structure or ceiling track. Curtains are traditionally hung from ceiling mounted tracks that allow for the curtains to be moved around the patient's bed to provide for privacy. Curtains are traditionally grabbed and moved by many people inside the facility throughout the course of one day. This creates an opportunity to spread bacteria as traditional privacy curtain fabric provides an environment for germs and bacteria to live and spread. Traditionally privacy curtains have not been changed frequently enough and have been a subject of ongoing controversy in the hospital setting. They can be touched by thousands before being removed for sanitization thus creating a safe harbor for the spread of germs and bacteria. The present invention solves this problem by allowing for routine maintenance in between complete removal in an effort to provide a safe handling zone for the maneuvering of privacy curtains.

### SUMMARY OF THE INVENTION

The present invention is for the purpose of providing a removable cleanable surface on the front and back handhold points on a privacy curtain. This is achieved by using removable medical grade impervious antimicrobial handhold panels that are attached to the curtain via snaps or Velcro or some other fastener. Without limitation, the removable panels can be comprised of vinyl, polyester, or 100% non-woven polypropylene and the attaching fasteners can include, but not be limited to, buttons, zippers, and hook and loop fasteners. The impervious panels can be easily removed for more frequent sanitization with traditional disinfectants and or laundered as part of the standard privacy curtain laundering process. Such panels can be vinyl in one embodiment, but can be made from any impervious antimicrobial material.

It should be understood that the disclosure of the use of Velcro or snap fasteners and the use of vinyl as a impervious antimicrobial panels in this application is not meant to limit the reach of the invention described herein, specifically to exclude coverage hereunder for other types of suitable fasteners, such as buttons and buttonholes, or other impervious materials for said panel.

### BRIEF DESCRIPTION OF THE DRAWINGS

FIG. 1 is a front view of a portion of the curtain of the present invention.

FIG. 2 is an exploded front view of a first embodiment of the curtain of the present invention.

FIG. 3 is an exploded front view of a second embodiment of the curtain of the present invention.

FIG. 4 is a front view of the curtain of the present invention.

### DETAILED DESCRIPTION OF THE INVENTION

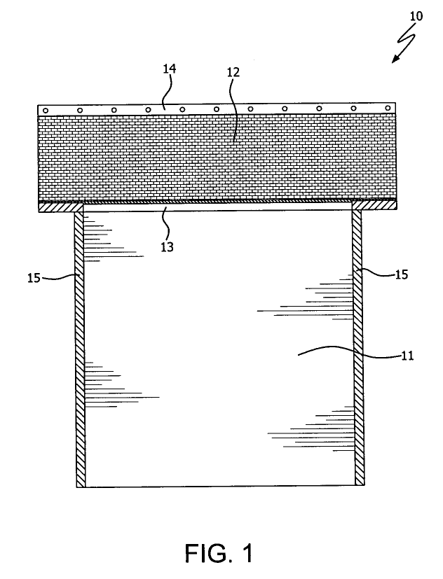

FIG. 1 depicts the base portion of hospital curtain 10 of the present invention consisting of a sheet 11 made of inherently flame retardant fabric attached at its top by fabric piece 13 to a header 12 made of open mesh. Curtain 10 has a top fabric piece 14 that allows said curtain to be hung from a rod or track installed on the ceiling of a hospital room or medical treatment facility. L-shaped attaching pieces 15 are affixed to each side of sheet 11 that provide for attachment by way of Velcro or snaps, depending on the embodiment of the invention chosen, as described below.

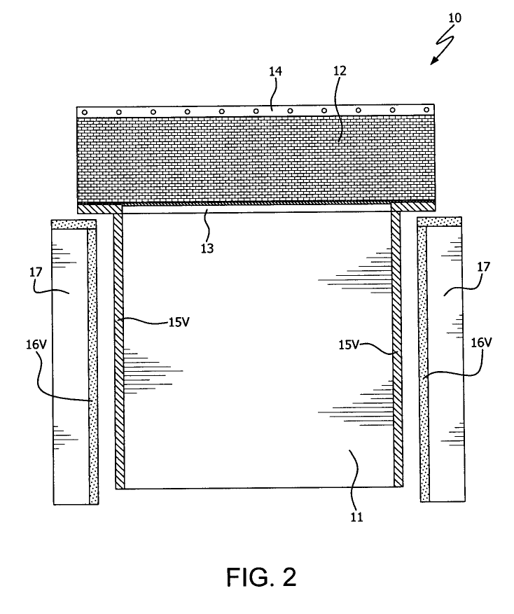

One embodiment of the present invention is shown in FIG. 2 which is based on using Velcro (hook and loop) fasteners to attach each of two removable medical grade impervious antimicrobial panels 17 to each side of sheet 11 of curtain 10. Each panel 17 has an L-shaped Velcro (hook or loop) fastener strap spanning attaching piece 16v affixed to its edge that is juxtaposed in the same relationship to the respective Velcro (being the opposite, loop or hook) attaching piece 15v on each side of sheet 11 of said curtain 10.

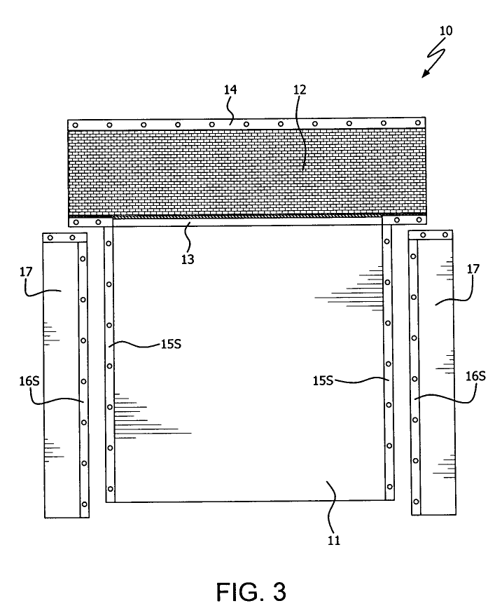

A second embodiment is shown in FIG. 3 in which snap fasteners (interlocking metal or plastic discs attached by riveting) are used to replace Velcro fasteners on both attaching pieces 16s of each panel 17 and on both attaching pieces 15s on each side of sheet 11.

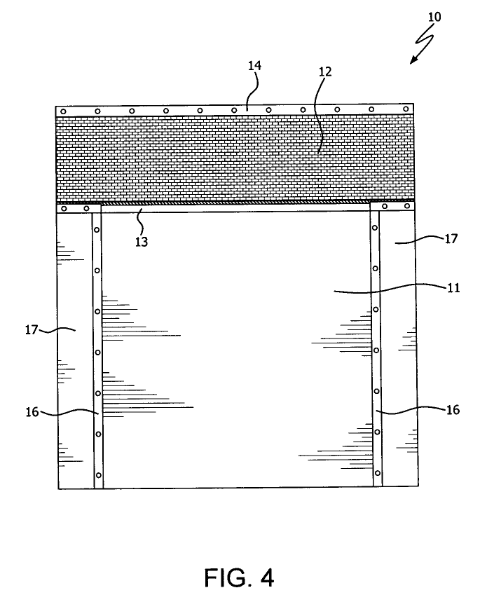

FIG. 4 depicts a fully assembled curtain 10 having panels 17 attached at either side of sheet 11 by using fastening systems as described in either embodiment above, that is by way of Velcro fasteners as in FIG. 2 or by way of snap fasteners as in FIG. 3, such that each attaching piece 16 attaches to and covers its respective attaching piece 15 (not shown in FIG. 4 as obscured by covering pieces 16). In either embodiment, vinyl sheets 17 at each side of sheet 11 of curtain 10 provide an antimicrobial impervious gripping surface that is exclusively used to move said curtain 10 in order to avoid the buildup of bacteria on said curtain 10. Each such sheet 17 can be readily disengaged from curtain 10 for cleaning by undoing the fasteners, whether Velcro as in FIG. 2 or snaps as in FIG. 3.

In the preferred embodiment of this invention, panels 17 are made of vinyl; however, it should be understood that the disclosure of the use of Velcro or snap fasteners and the use of vinyl in order to manufacture the impervious antimicrobial panels 17 in this application is not meant to limit the reach of the invention described herein, specifically to exclude coverage hereunder for other types of suitable fasteners, such as buttons and buttonholes, or other medical grade impervious antimicrobial materials for said panel.

What is claimed is:

1. A sanitary curtain assembly comprising:
a sheet;
a header attached to the top of said sheet having apparatus for hanging thereon; and
a first panel constructed from medical grade impervious antimicrobial material removably attached to a first side of said sheet.

2. The sanitary curtain assembly of claim 1 further comprising:
a second panel constructed from medical grade impervious antimicrobial material removably attached a second side of said sheet.

3. The sanitary curtain assembly of claim 2 in which said header is attached to the top of said sheet by a strip of fabric.

4. The sanitary curtain assembly of claim 1 in which said first panel is removably attached to said first side of said sheet with an L shaped attaching piece.

5. The sanitary curtain assembly of claim 2 in which said second panel is removably attached to said second side of said sheet with an L shaped attaching piece.

6. The sanitary curtain assembly of claim 2 in which the means for removably attaching said first panel and said second panel to said sheet are selected from a group comprised of Velcro fasteners and snap fasteners.

7. The sanitary curtain assembly of claim 1 and claim 2 in which said medical grade impervious antimicrobial material is vinyl.

8. In a hospital curtain, the improvement comprising:
a first panel constructed from medical grade impervious antimicrobial material removably attached to a first side of said curtain;
a second panel constructed from medical grade impervious antimicrobial material removably attached a second side of said curtain,
wherein the means for removably attaching said first panel and said second panel to said curtain are selected from a group comprised of Velcro fasteners and snap fasteners.

9. In the improvement of claim 8, said first panel and said second panel being constructed from vinyl.
